(19) United States
(12) Patent Application Publication
(10) Pub. No.: US 2025/0233202 A1
(43) Pub. Date: Jul. 17, 2025

(54) SOLID ELECTROLYTE FOR LITHIUM SECONDARY BATTERY INCLUDING SUBSTITUTION ELEMENT AND METHOD OF MANUFACTURING SAME

(71) Applicant: The Industry & Academic Cooperation in Chungnam National University (IAC), Daejeon (KR)

(72) Inventors: Dohun Kim, Daejeon (KR); Minh Hai Nguyen, Daejeon (KR); Seung Hoon Chun, Seoul (KR); Sangbaek Park, Sejong-si (KR)

(73) Assignee: The Industry & Academic Cooperation in Chungnam National University (IAC), Daejeon (KR)

(21) Appl. No.: 18/960,685

(22) Filed: Nov. 26, 2024

(30) Foreign Application Priority Data
Jan. 16, 2024 (KR) 10-2024-0006991
Nov. 21, 2024 (KR) 10-2024-0167007

(51) Int. Cl. H01M 10/0562; H01M 10/052

(52) U.S. Cl. CPC H01M 10/0562; H01M 10/052; H01M 2300/0071; H01M 2300/0094

(57) ABSTRACT

Disclosed are a solid electrolyte for a lithium secondary battery including a substitution element such as gallium (Ga), etc. and a method of manufacturing the same.

### CROSS-REFERENCE TO RELATED APPLICATION

This application claims, under 35 U.S.C. § 119(a), the benefit of priority from Korean Patent Application No. 10-2024-0006991, filed on Jan. 16, 2024, and Korean Patent Application No. 10-2024-0167007, filed on Nov. 21, 2024, the entire contents of which are incorporated herein by reference.

### BACKGROUND

### (a) Technical Field

The present disclosure relates to a solid electrolyte for a lithium secondary battery including a substitution element such as gallium (Ga), etc. and a method of manufacturing the same.

### (b) Background Art

Li₇La₃Zr₂O₁₂ (LLZO), an oxide-based solid electrolyte with a garnet structure, is receiving a lot of attention as a promising next-generation solid electrolyte due to high lithium ion conductivity (10⁻³ to 10⁻⁴ S·cm⁻¹), stability with lithium metal, a wide potential window range (0 to 4.5-9 V), and the like.

The representative crystal structures of LLZO include tetragonal phase and cubic phase. The lithium ion conductivity of the cubic phase is about 100 or more times that of the tetragonal phase. Accordingly, researchers have performed a study to obtain the highest possible proportion of cubic phase when synthesizing LLZO. However, the cubic structure is unstable at room temperature, and lithium volatilizes due to the high temperature during sintering, leading to a decrease in the concentration of lithium ions in the garnet structure. Therefore, many researchers have substituted lithium ions at the lithium site with cations such as Ga³⁺, Al³⁺, etc. to stabilize the cubic phase at room temperature. Lithium vacancies are created to balance charges within the crystal structure. Such lithium vacancies increase entropy, reducing the Gibbs free energy, thereby stabilizing the cubic structure.

Thereamong, LLZO doped with gallium (Ga) has a sintering temperature of 1,200° C. or less in addition to stabilizing the cubic phase. Li—Ga—O is formed by reaction of gallium (Ga) and lithium (Li). The eutectic point of Li—Ga—O is about 975° C., so liquid phase sintering occurs. Liquid phase sintered LLZO has high density, which means high lithium ion conductivity. However, in cases in which gallium located at the grain boundary is exposed to molten lithium, the volume thereof expands rapidly, causing structural collapse of the LLZO pellet. Therefore, development has been conventionally carried out in the direction of suppressing Li—Ga—O at the grain boundary. For example, there have been developed methods of reducing the reaction with lithium metal by adding silicon dioxide (SiO₂) powder to gallium-doped LLZO powder to form Li₂SiO₃ at the grain boundary instead of Li—Ga—O during sintering. However, since Li₂SiO₃, which is insulative, blocks the conduction of lithium ions, the problem of lowering lithium ion conductivity occurs. Accordingly, the present disclosure is intended to solve conventional problems with Li—Ga—O and to explore ways for utilizing the advantages of Li—Ga—O such as stabilization of the cubic phase and improvement of density and lithium ion conductivity.

### SUMMARY OF THE DISCLOSURE

Therefore, an object of the present disclosure is to provide a solid electrolyte for a lithium secondary battery with high lithium ion conductivity and a method of manufacturing the same.

Another object of the present disclosure is to provide a solid electrolyte for a lithium secondary battery with high relative density and a method of manufacturing the same.

Still another object of the present disclosure is to provide a solid electrolyte for a lithium secondary battery with excellent wettability to lithium and a method of manufacturing the same.

Yet another object of the present disclosure is to provide a solid electrolyte for a lithium secondary battery with low interfacial resistance and a method of manufacturing the same.

Still yet another object of the present disclosure is to provide a solid electrolyte for a lithium secondary battery with excellent charge/discharge stability and a method of manufacturing the same.

The objects of the present disclosure are not limited to the foregoing. The objects of the present disclosure will be able to be clearly understood through the following description and to be realized by the means described in the claims and combinations thereof.

An embodiment of the present disclosure provides a solid electrolyte for a lithium secondary battery, including lithium oxide including at least one substitution element selected from the group consisting of gallium (Ga), aluminum (Al), tantalum (Ta), and combinations thereof and having a predetermined shape, a coating layer including a noble metal and located on a surface of the lithium oxide, and an intermediate layer including an alloy of the substitution element and the noble metal and located between the lithium oxide and the coating layer.

The lithium oxide may include a plurality of grains and a grain boundary between the grains, and a metal derived from the substitution element may be precipitated along the grain boundary.

The lithium oxide may be represented by Chemical Formula 1 below.

LiₐAl_{b}Ga_{c}La₃Zr_{d}TaₑO₁₂ [Chemical Formula 1]

In Chemical Formula 1, a, b, c, d, and e may be 6≤a≤8, 0<b<1, 0<c<1, 1<d<2, and 0<e<1, with satisfying d+e=2.

The lithium oxide may be represented by Chemical Formula 2 below.

Li_{7n-0.966}Al_{0.172}Ga_{0.144}La₃Zr_{1.982}Ta_{0.018}O₁₂ [Chemical Formula 2]

In Chemical Formula 2, n may be 1.03<n<1.2.

The lithium oxide may be represented by Chemical Formula 3 below.

Li_{7.7-3m-0.534}Al_{0.172}GaₘLa₃Zr_{1.982}Ta_{0.018}O₁₂ [Chemical Formula 3]

In Chemical Formula 3, m may be 0<m≤0.178.

The lithium oxide may be a sintered body.

The lithium oxide may have a relative density of 90% or more.

The lithium oxide may have a surface roughness Rₐ of 100 nm or less.

The noble metal may include at least one selected from the group consisting of silver (Ag), gold (Au), platinum (Pt), and combinations thereof.

The lithium oxide may be blocked from outside by the intermediate layer.

The intermediate layer may include an alloy of gallium (Ga) and gold (Au).

The intermediate layer may have a thickness of 1 nm to 10 nm.

Another embodiment of the present disclosure provides a method of manufacturing a solid electrolyte for a lithium secondary battery, including preparing lithium oxide including at least one substitution element selected from the group consisting of gallium (Ga), aluminum (Al), tantalum (Ta), and combinations thereof and having a predetermined shape, precipitating a metal derived from the substitution element along a grain boundary of the lithium oxide by sintering the lithium oxide, polishing a surface of the sintered lithium oxide, obtaining an intermediate by forming a coating layer including a noble metal on the polished surface of the lithium oxide, and forming an intermediate layer located between the lithium oxide and the coating layer and including the substitution element and the noble metal by resting the intermediate.

The method may further include pulverizing the lithium oxide by ball milling at a speed of 100 rpm to 300 rpm for 1 hour to less than 12 hours, before sintering the lithium oxide.

Precipitating the metal may include sintering the lithium oxide at 1,000° C. to 2,000° C. for 10 minutes to 200 minutes.

The coating layer may be formed by depositing the noble metal on the polished surface of the lithium oxide.

Forming the intermediate layer may include resting the intermediate at 15° C. to 25° C. for 10 minutes to 2 hours.

### BRIEF DESCRIPTION OF THE DRAWINGS

The above and other features of the present disclosure will now be described in detail referring to certain exemplary embodiments thereof illustrated in the accompanying drawings, which are given hereinbelow by way of illustration only, and thus are not limitative of the present disclosure, and wherein:

FIG. 1 shows a lithium secondary battery according to the present disclosure;

FIG. 2 shows a solid electrolyte according to the present disclosure;

FIG. 3A schematically shows the internal structure of lithium oxide according to the present disclosure;

FIG. 3B shows sintered lithium oxide and a precipitated metal;

FIG. 4 shows results of measurement of the surface roughness of lithium oxide according to Example 1;

FIG. 5 shows results of analyzing the cross section of a solid electrolyte according to Comparative Example 1 using a scanning electron microscope and an energy dispersive spectrometer;

FIG. 6 shows results of analyzing the cross section of a solid electrolyte according to Comparative Example 2 using a scanning electron microscope and an energy dispersive spectrometer;

FIG. 7 shows a Nyquist plot of a coin cell according to Comparative Example 1.

FIG. 8 shows results of measurement of the galvanostatic cycling of coin cells according to Comparative Examples 1 and 2;

FIG. 9 shows a Nyquist plot of the coin cell according to Comparative Example 2.

FIG. 10 shows Nyquist plots of coin cells according to Example 1 and Comparative Examples 3 and 4;

FIG. 11 shows results of measurement of the galvanostatic cycling of the coin cells according to Example 1 and Comparative Examples 3 and 4;

FIG. 12 shows Nyquist plots of coin cells according to Comparative Examples 5 and 6;

FIG. 13 shows results of measurement of the galvanostatic cycling of the coin cell according to Comparative Example 5;

FIG. 14 shows results of measurement of the galvanostatic cycling of the coin cell according to Comparative Example 6;

FIG. 15 shows pelletized solid electrolytes of Examples 2 to 4 and Comparative Examples 7 to 9;

FIG. 16 shows results of X-ray diffraction analysis of the solid electrolytes according to Examples 2 to 4 and Comparative Examples 7 to 9;

FIG. 17 shows results of measurement of lithium ion conductivity of the solid electrolytes according to Examples 2 to 4 and Comparative Examples 7 to 9;

FIG. 18 shows results of Raman analysis of the solid electrolyte according to Example 4;

FIG. 19 shows results of analyzing the solid electrolytes according to Examples 2 to 4 and Comparative Examples 7 to 9 using a scanning electron microscope and an energy dispersive spectrometer;

FIG. 20 shows pelletized solid electrolytes of Examples 5 to 8 and Comparative Example 10;

FIG. 21 shows results of X-ray diffraction analysis of the solid electrolytes according to Examples 5 to 8 and Comparative Example 10;

FIG. 22 shows results of analyzing the solid electrolytes according to Examples 5 to 8 and Comparative Example 10 using a scanning electron microscope;

FIG. 23 shows results of measurement of relative density of the solid electrolytes according to Examples 5 to 8 and Comparative Example 10;

FIG. 24 shows results of measurement of lithium ion conductivity of the solid electrolytes according to Examples 5 to 8 and Comparative Example 10;

FIG. 25 shows results of X-ray diffraction analysis of the solid electrolytes according to Example 7 and Comparative Example 10;

FIG. 26 shows results of X-ray photoelectron spectroscopy of the solid electrolyte according to Example 7;

FIG. 27a shows results of analyzing solid electrolytes according to Comparative Examples 11 using a scanning electron microscope and an energy dispersive spectrometer;

FIG. 27b shows results of analyzing solid electrolytes according to Examples 9 using a scanning electron microscope and an energy dispersive spectrometer;

FIG. 27c shows results of analyzing solid electrolytes according to Examples 10 using a scanning electron microscope and an energy dispersive spectrometer;

FIG. 27d shows results of analyzing solid electrolytes according to Examples 11 using a scanning electron microscope and an energy dispersive spectrometer;

FIG. 28 shows scanning electron microscope images of solid electrolytes according to Example 12 and Comparative Example 12;

FIG. 29 shows scanning electron microscope images of solid electrolytes according to Example 13 and Comparative Example 13; and

FIG. 30 shows scanning electron microscope images of solid electrolytes according to Example 14 and Comparative Example 14.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

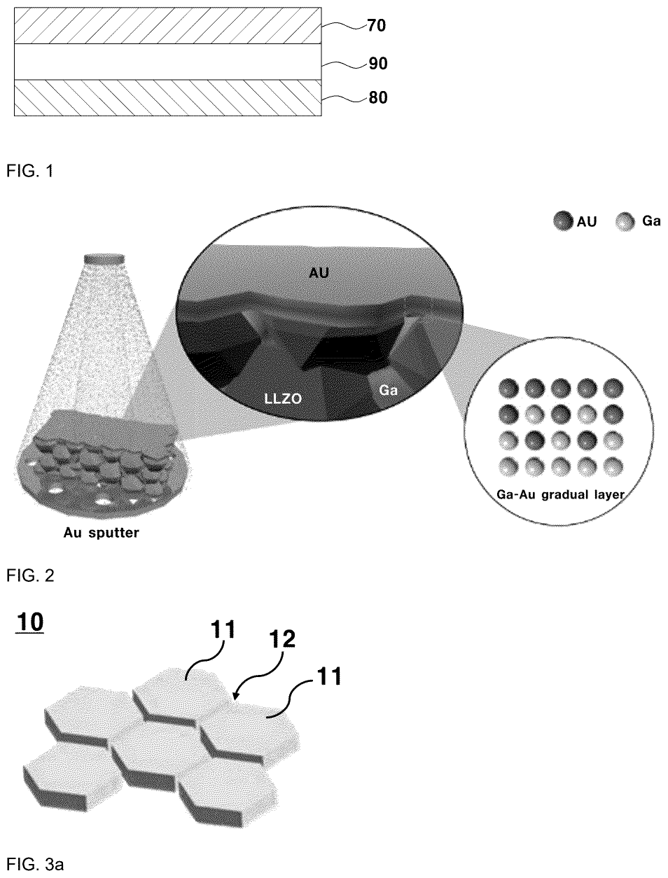

FIG. 1 shows a lithium secondary battery according to the present disclosure. The lithium secondary battery may include a cathode 70, an anode 80, and a solid electrolyte layer 90 located between the cathode 70 and the anode 80.

At least one selected from among the cathode 70, the anode 80, and the solid electrolyte layer 90 may include a solid electrolyte according to the present disclosure. The solid electrolyte is responsible for conducting lithium ions in each component.

The configuration, specifications, shape and the like of the cathode 70, the anode 80, and the solid electrolyte layer 90 may be the same as or similar to those commonly used in the art to which the present disclosure pertains. Thus, a description thereof will be omitted below.

FIG. 2 shows a solid electrolyte 100 according to the present disclosure. The solid electrolyte 100 may include lithium oxide 10 including a substitution element such as gallium (Ga), etc. and having a predetermined shape, a coating layer 20 located on the surface of the lithium oxide 10, and an intermediate layer 30 located between the lithium oxide 10 and the coating layer 20.

The lithium oxide 10 may be based on LLZO and doped with at least one substitution element selected from the group consisting of gallium (Ga), aluminum (Al), tantalum (Ta), and combinations thereof. Preferably, the lithium oxide 10 is LLZO doped with gallium (Ga), aluminum (Al), and tantalum (Ta).

The lithium oxide 10 may be represented by Chemical Formula 1 below.

LiₐAl_{b}Ga_{c}La₃Zr_{d}TaₑO₁₂ [Chemical Formula 1]

In Chemical Formula 1, a, b, c, d, and e may be 6≤a≤8, 0<b<1, 0<c<1, 1<d<2, and 0<e<1, with satisfying d+e=2.

A specific example of the lithium oxide 10 may be represented by Chemical Formula 2 below.

Li_{7n-0.966}Al_{0.172}Ga_{0.144}La₃Zr_{1.982}Ta_{0.018}O₁₂ [Chemical Formula 2]

In Chemical Formula 2, n may be 1.03<n<1.2.

The lithium oxide 10 represented by Chemical Formula 2 may be obtained by adjusting the number of moles of lithium to an excessive extent.

Another specific example of the lithium oxide 10 may be represented by Chemical Formula 3 below.

Li_{7.7-3m-0.534}Al_{0.172}GaₘLa₃Zr_{1.982}Ta_{0.018}O₁₂ [Chemical Formula 3]

In Chemical Formula 3, m may be 0<m≤0.178.

The lithium oxide 10 represented by Chemical Formula 3 may be obtained by adjusting the amount of doped gallium (Ga).

The gallium (Ga) may be precipitated by adjusting the number of moles of lithium in the lithium oxide 10 to an excessive extent or by adjusting the amount of doped gallium (Ga). Specifically, compared to a precipitation method of synthesizing LLZO and then reheating the same by mixing an additive including gallium (Ga), the present disclosure is capable of precipitating gallium (Ga) more simply because only the composition ratio of the lithium oxide 10 is adjusted, which is described in more detail below.

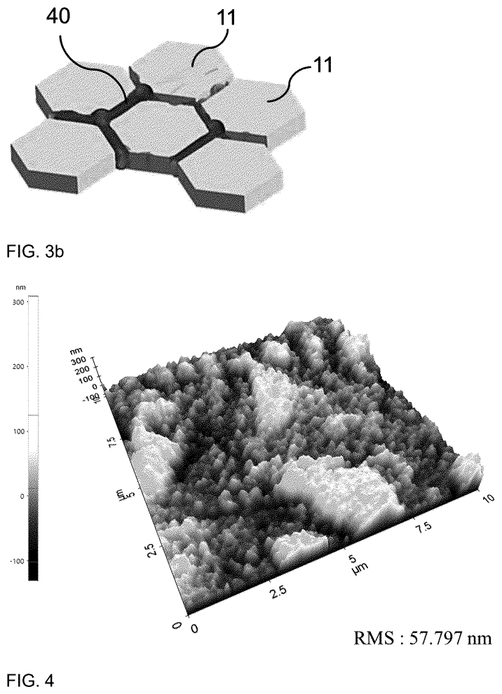

FIG. 3A schematically shows the internal structure of lithium oxide 10 according to the present disclosure. The lithium oxide 10 may include a plurality of grains 11 and a grain boundary 12 between the grains 11.

When the lithium oxide 10 is sintered under conditions of a predetermined temperature and time, a metal 40 derived from the substitution element may be precipitated along the grain boundary 12, as shown in FIG. 3B. FIG. 3B shows the sintered lithium oxide 10 and the precipitated metal 40. The metal 40 may include gallium (Ga). The pores and the grain boundary 12 of the lithium oxide 10 may be physically filled with the precipitated gallium (Ga), thereby lowering the interfacial resistance between the grains 11. Also, the precipitated gallium (Ga) and/or compounds based thereon provide a path for lithium ions, so that the lithium ions may move more easily between the grains 11. Thereby, lithium ion conductivity of the solid electrolyte 100 may be improved.

The relative density of the lithium oxide 10 may be 90% or more. The relative density may be a value calculated using Archimedes' principle. The lithium oxide 10 includes gallium (Ga) as a substitution element, and the gallium (Ga) makes the lithium oxide 10 compact, so the lithium oxide 10 has a high relative density. A high relative density means that lithium ions may move more easily, and thus the solid electrolyte according to the present disclosure is characterized by higher lithium ion conductivity than conventional LLZO, etc.

The surface roughness Rₐ of the lithium oxide 10 may be 1 μm or less, 500 nm or less, 300 nm or less, or 100 nm or less. The surface roughness Rₐ may indicate arithmetic average roughness. The lower limit of the surface roughness Rₐ is not particularly limited, and may be, for example, 1 nm or more, 3 nm or more, or 5 nm or more. When the surface roughness Rₐ of the lithium oxide 10 falls within the above range, the coating layer 20 and the intermediate layer 30 may be uniformly formed.

The coating layer 20 may include a noble metal including at least one selected from the group consisting of silver (Ag), gold (Au), platinum (Pt), and combinations thereof. Preferably, the coating layer 20 includes gold (Au).

When the coating layer 20 is formed on the surface of the lithium oxide 10, the metal 40 and the noble metal of the coating layer 20 may be alloyed on the surface of the lithium oxide 10 to form the intermediate layer 30. Specifically, the intermediate layer 30 may include an alloy of the metal 40 derived from the substitution element and the noble metal, preferably an alloy of gallium (Ga) and gold (Au), particularly GaAu₂.

The coating layer 20 and the intermediate layer 30 may serve to block the lithium oxide 10 from the outside, thus preventing the structure of the lithium oxide 10 from being destroyed by contact and reaction of the metal 40 with external molten lithium (Li).

Also, the intermediate layer 30 may facilitate the transfer of charges from lithium (Li) to the lithium oxide 10 to thus lower interfacial resistance, thereby improving performance of the battery including the solid electrolyte 100.

The thickness of the intermediate layer 30 may be 1 nm to 10 nm. When the thickness of the intermediate layer 30 falls within the above range, the effect thereof may be appropriately implemented.

A method of manufacturing the solid electrolyte for a lithium secondary battery according to the present disclosure may include preparing lithium oxide including at least one substitution element selected from the group consisting of gallium (Ga), aluminum (Al), tantalum (Ta), and combinations thereof and having a predetermined shape, precipitating a metal derived from the substitution element along a grain boundary of the lithium oxide by sintering the lithium oxide, polishing the surface of the sintered lithium oxide, obtaining an intermediate by forming a coating layer including a noble metal on the polished surface of the lithium oxide, and forming an intermediate layer located between the lithium oxide and the coating layer and including the substitution element and the noble metal by resting the intermediate.

Preparing the lithium oxide may include preparing a starting material by mixing the precursors of individual elements followed by pulverizing and heat-treating the starting material.

The precursors are not particularly limited and may include a lithium precursor, a lanthanum precursor, a zirconium precursor, a gallium precursor, an aluminum precursor, and a tantalum precursor. Examples thereof may include carbonates, oxides, and the like including individual elements, and preferably include Li₂CO₃, La₂O₃, ZrO₂, Ga₂O₃, Al₂O₃, and Ta₂O₅.

The manufacturing method may further include, before sintering the lithium oxide, pulverizing the lithium oxide by ball milling at a speed of 100 rpm to 300 rpm for 1 hour to less than 12 hours. When the pulverization conditions fall within the above range, the relative density of lithium oxide may be increased through sintering.

Meanwhile, the manufacturing method may further include mixing the pulverized lithium oxide with a binder and then pelletizing the same into a predetermined shape. The type of binder is not particularly limited and may include, for example, polyvinyl alcohol (PVA), etc. The predetermined shape is not particularly limited, and examples thereof may include a cylindrical shape, a spherical shape, a coin shape, and the like.

Precipitating the metal may include sintering the lithium oxide at 1,000° C. to 2,000° C. for 10 minutes to 200 minutes. If the lithium oxide is sintered to a temperature less than 1,000° C., the extent of precipitation of gallium (Ga) may not be sufficient.

The coating layer may be formed by depositing a noble metal on the polished surface of the lithium oxide, and the intermediate thus obtained may be rested at 15° C. to 25° C. for 10 minutes to 2 hours so that the noble metal and gallium (Ga) are naturally alloyed, thereby forming the intermediate layer.

A better understanding of the present disclosure may be obtained through the following examples and comparative examples. However, these examples are not to be construed as limiting the technical spirit of the present disclosure.

### Example 1

A starting material was prepared by weighing and mixing Li₂CO₃, La₂O₃, ZrO₂, Ga₂O₃, Al₂O₃, and Ta₂O₅ according to the composition shown in Table 1 below. The starting material was pulverized using a planetary ball mill. The result was dried and then heat-treated in a furnace, yielding lithium oxide as shown in Table 1.

The lithium oxide was pulverized using a planetary ball mill. The result was mixed with a polyvinyl alcohol solution as a binder, placed in a mold with a diameter of about 20 mm, and pressurized at a pressure of about 72 MPa to obtain pellets. The pellets were sintered at a furnace.

The surface of the sintered lithium oxide was polished with sandpaper as shown in Table 1. FIG. 4 shows results of measurement of the surface roughness of the lithium oxide according to Example 1. Referring thereto, the surface roughness of the lithium oxide was determined to be about 57.797 nm, indicating that the surface roughness of the lithium oxide according to the present disclosure was 100 nm or less.

A coating layer was formed by depositing gold (Au) on both polished surfaces of the lithium oxide using a sputter coater (SCD 005, Bal-Tec, Milton, NY, USA). The deposition conditions are shown in Table 1.

The intermediate thus obtained was rested at about 15° C. to 25° C. for about 1 hour to form an intermediate layer, thereby completing a solid electrolyte.

A CR2032 coin cell with a lithium symmetrical structure was manufactured by attaching molten lithium to both sides of the solid electrolyte.

### Comparative Example 1

A solid electrolyte was manufactured in the same manner as in Example 1, with the exception that a starting material was prepared by weighing and mixing the precursors according to the composition shown in Table 1 below without using a gallium precursor and also that the coating layer and the intermediate layer were not formed.

A CR2032 coin cell with a lithium symmetrical structure was manufactured by attaching molten lithium to both sides of the solid electrolyte.

### Comparative Example 2

A solid electrolyte was manufactured in the same manner as in Example 1, with the exception that the coating layer and the intermediate layer were not formed.

A CR2032 coin cell with a lithium symmetrical structure was manufactured by attaching molten lithium to both sides of the solid electrolyte.

### Comparative Example 3

A solid electrolyte was manufactured in the same manner as in Example 1, with the exception that a starting material was prepared by weighing and mixing the precursors according to the composition shown in Table 1 below without using a gallium precursor.

A CR2032 coin cell with a lithium symmetrical structure was manufactured by attaching molten lithium to both sides of the solid electrolyte.

### Comparative Examples 4 to 6

Each solid electrolyte was manufactured in the same manner as in Example 1, with the exception that the polishing conditions of the sintered lithium oxide and the deposition time of the coating layer were changed as shown in Table 1 below.

A CR2032 coin cell with a lithium symmetrical structure was manufactured by attaching molten lithium to both sides of the solid electrolyte.

TABLE 1

| | | | Deposition | | | |
|---|---|---|---|---|---|---|
| | | Presence | of coating | Deposition | | Polishing |
| Classification | Composition | of gallium | layer | time | | conditions¹⁾ |
| Comparative | Li_{7.166}Al_{0.172}La₃Zr_{1.982}Ta_{0.018}O₁₂ | X | X | — | | 5,000 |
| Example 1 | | | | | | |
| Comparative | Li_{6.734}Al_{0.172}Ga_{0.142}La₃Zr_{1.982}Ta_{0.018}O₁₂ | ◯ | X | — | | 5,000 |
| Example 2 | | | | | | |
| Comparative | Li_{7.166}Al_{0.172}La₃Zr_{1.982}Ta_{0.018}O₁₂ | X | ◯ | 20 | sec | 5,000 |
| Example 3 | | | | | | |
| Example 1 | Li_{6.734}Al_{0.172}Ga_{0.142}La₃Zr_{1.982}Ta_{0.018}O₁₂ | ◯ | ◯ | 20 | sec | 5,000 |
| Comparative | | ◯ | ◯ | 120 | sec | 5,000 |
| Example 4 | | | | | | |
| Comparative | | ◯ | ◯ | 20 | sec | 220 |
| Example 5 | | | | | | |
| Comparative | | ◯ | ◯ | 120 | sec | 220 |
| Example 6 | | | | | | |

¹⁾Grit of sandpaper used in polishing step.

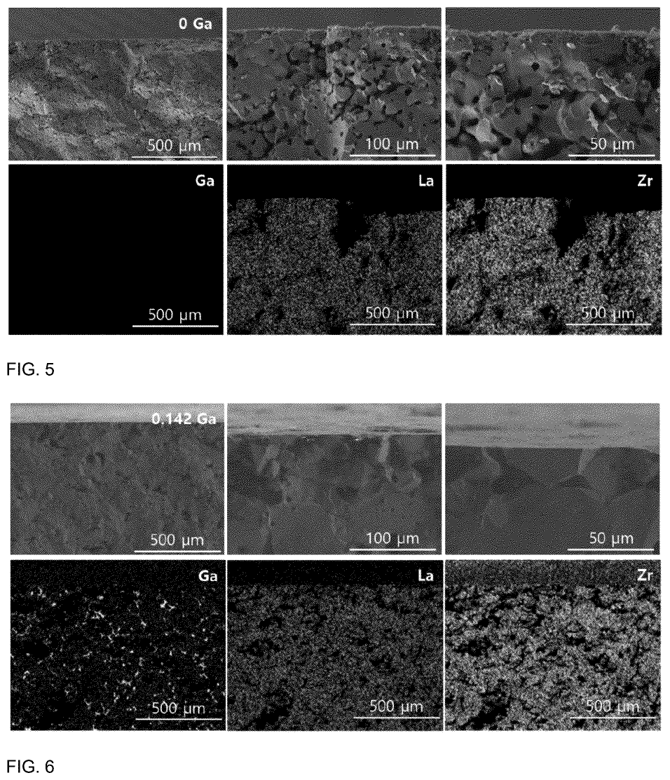

FIG. 5 shows results of analyzing the cross section of the solid electrolyte according to Comparative Example 1 using a scanning electron microscope and an energy dispersive spectrometer. Referring thereto, the solid electrolyte according to Comparative Example 1 did not include gallium, indicating that the grain boundary was empty.

FIG. 6 shows results of analyzing the cross section of the solid electrolyte according to Comparative Example 2 using a scanning electron microscope and an energy dispersive spectrometer. Referring thereto, the solid electrolyte according to Comparative Example 2 included gallium, so gallium precipitated in the grains was present.

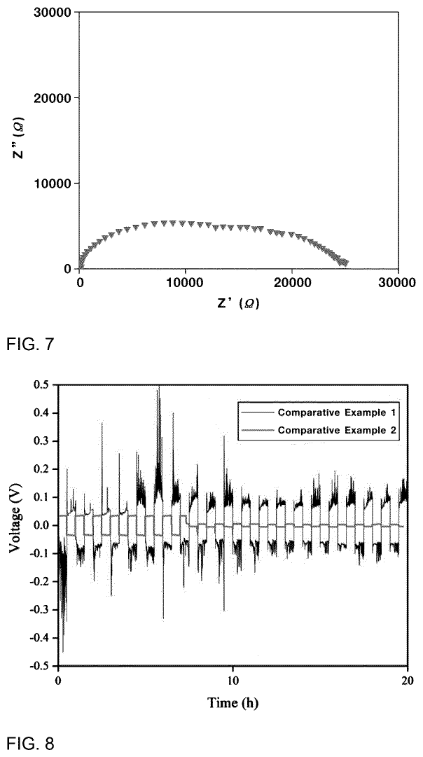

FIG. 7 shows a Nyquist plot of the coin cell according to Comparative Example 1. FIG. 8 shows results of measurement of the galvanostatic cycling of the coin cells according to Comparative Examples 1 and 2 at 0.1 mA·cm⁻². Referring to FIG. 7, the grain boundary resistance and interfacial resistance of the coin cell according to Comparative Example 1 were very high to the levels of 9,788Ω and 12,530Ω, respectively. Also, referring to FIG. 8, the coin cell of Comparative Example 1 had high grain boundary resistance, indicating a high voltage of 0.4 V or more in the first cycle and then a short circuit due to a voltage drop.

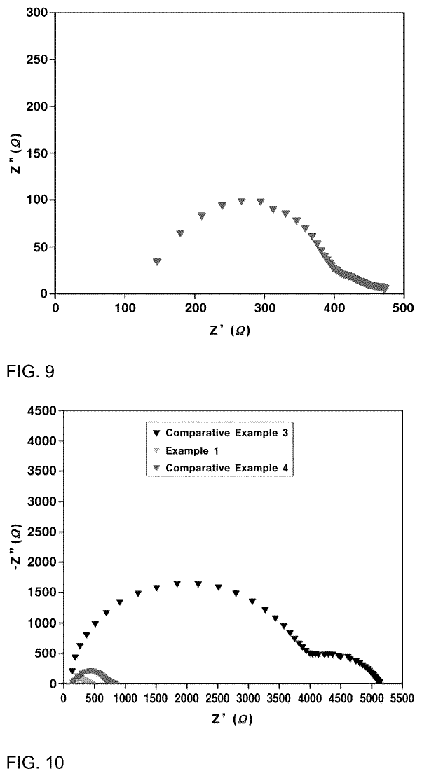

FIG. 9 shows a Nyquist plot of the coin cell according to Comparative Example 2. Referring thereto, the grain boundary resistance and interfacial resistance of the coin cell according to Comparative Example 2 were 258Ω and 90.2Ω, respectively, which are lower than those of Comparative Example 1. However, referring to FIG. 8, the coin cell of Comparative Example 2 operated stably for 7 cycles, but gallium at the grain boundary was then used as a path for lithium to move, resulting in a short circuit, which was evidenced by a voltage drop.

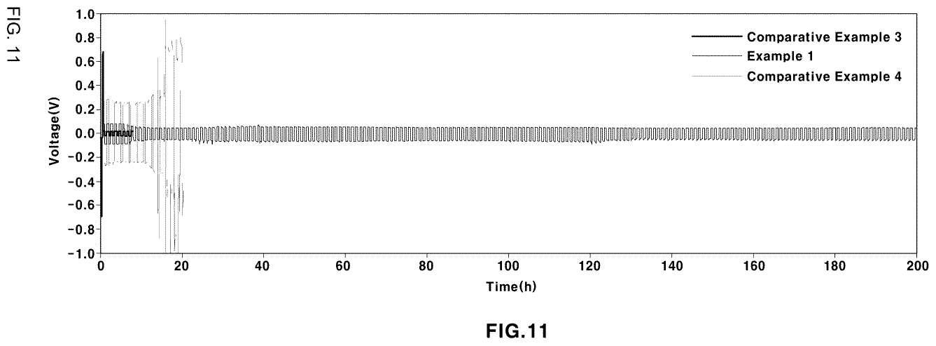

FIG. 10 shows Nyquist plots of the coin cells according to Example 1 and Comparative Examples 3 and 4. FIG. 11 shows results of measurement of the galvanostatic cycling of the coin cells according to Example 1 and Comparative Examples 3 and 4 at 0.1 mA·cm⁻².

Referring to FIG. 10, the coin cell of Comparative Example 3 had interfacial resistance of about 1,227Ω, which is lower than that of Comparative Example 1. This is deemed to be because wettability to lithium was improved by the coating layer. Meanwhile, referring to FIG. 11, the coin cell of Comparative Example 3 had high grain boundary resistance, indicating a high initial voltage of 0.6 V and then a voltage drop and a short circuit.

Referring to FIG. 10, the grain boundary resistance and interfacial resistance of the coin cell of Example 1 were 195.4Ω and 68.01Ω, respectively, which are lower than those of Comparative Example 3. Referring to FIG. 11, the coin cell of Example 1 operated stably for about 200 cycles because direct contact between molten lithium and gallium was prevented by the coating layer and the intermediate layer.

Referring to FIG. 10, the coin cell of Comparative Example 4 had grain boundary resistance and interfacial resistance of 215.5Ω and 455.1Ω, respectively, which are higher than those of Example 1. This is deemed to be because the coating layer became thick by an increase in the deposition time. Also, referring to FIG. 11, Comparative Example 4 operated with high resistance of 1 V or more due to the thick coating layer.

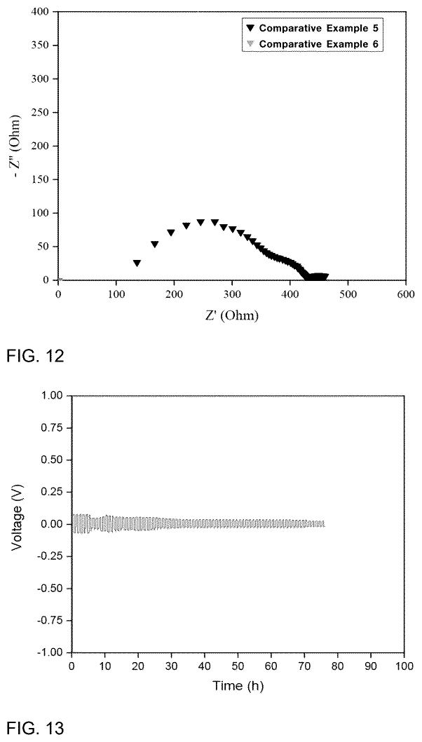

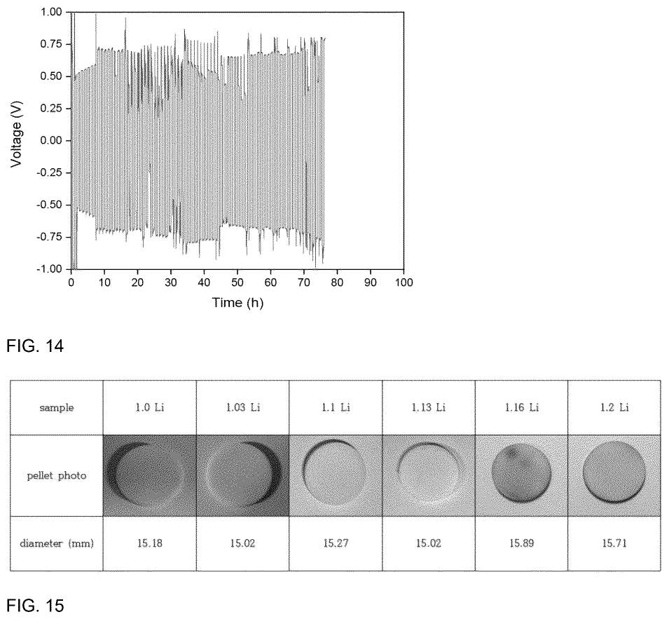

FIG. 12 shows Nyquist plots of the coin cells according to Comparative Examples 5 and 6. FIG. 13 shows results of measurement of the galvanostatic cycling of the coin cell according to Comparative Example 5 at 0.1 mA·cm⁻². FIG. 14 shows results of measurement of the galvanostatic cycling of the coin cell according to Comparative Example 6 at 0.1 mA·cm⁻².

Referring to FIG. 12, the grain boundary resistance and interfacial resistance of the coin cell according to Comparative Example 5 were 198Ω and 62.94Ω, respectively, which are similar to those of Example 1. However, referring to FIG. 13, the coin cell of Comparative Example 5 showed a voltage drop with an increase in the number of cycles due to the rough interface.

Referring to FIG. 12, the coin cell according to Comparative Example 6 showed a vertical upward trend with no measured semicircle, indicating a nonconductor. Also, referring to FIG. 14, the coin cell of Comparative Example 6 operated with a high voltage of 1 V or more.

### Examples 2 to 4 and Comparative Examples 7 to 9

Each solid electrolyte was manufactured in the same manner as Example 1, with the exception that the composition of lithium oxide was changed as shown in Table 2 below.

TABLE 2

| | Composition | |
|---|---|---|
| | (Chemical Formula 2: | n in Chemical |
| Classification | Li_{7n-0.966}Al_{0.172}Ga_{0.144}La₃Zr_{1.982}Ta_{0.018}O₁₂) | Formula 2 |
| Comparative | Li_{6.034}Al_{0.172}Ga_{0.144}La₃Zr_{1.982}Ta_{0.018}O₁₂ | 1.0 |
| Example 7 | | |
| Comparative | Li_{6.25}Al_{0.172}Ga_{0.144}La₃Zr_{1.982}Ta_{0.018}O₁₂ | 1.03 |
| Example 8 | | |
| Example 2 | Li_{6.734}Al_{0.172}Ga_{0.144}La₃Zr_{1.982}Ta_{0.018}O₁₂ | 1.1 |
| Example 3 | Li_{6.95}Al_{0.172}Ga_{0.144}La₃Zr_{1.982}Ta_{0.018}O₁₂ | 1.13 |
| Example 4 | Li_{7.154}Al_{0.172}Ga_{0.144}La₃Zr_{1.982}Ta_{0.018}O₁₂ | 1.16 |
| Comparative | Li_{7.434}Al_{0.172}Ga_{0.144}La₃Zr_{1.982}Ta_{0.018}O₁₂ | 1.2 |
| Example 9 | | |

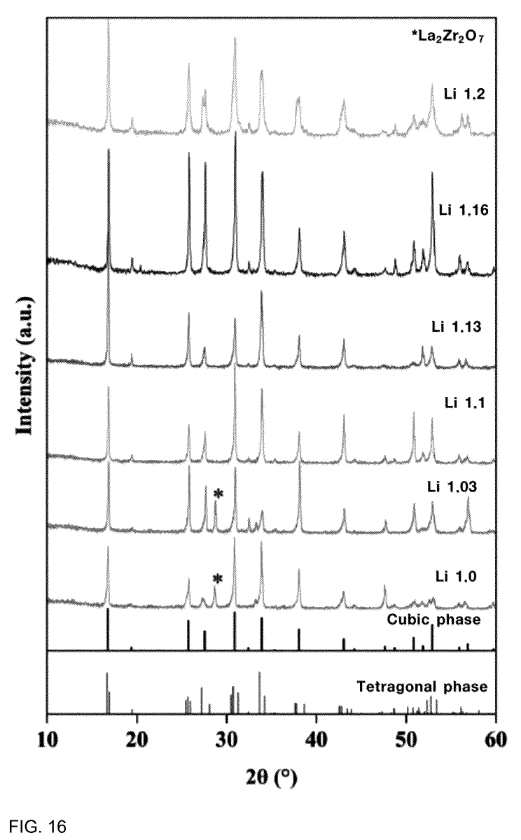

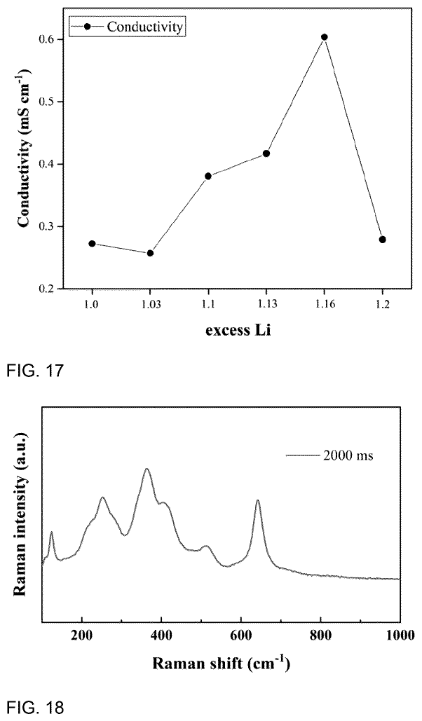

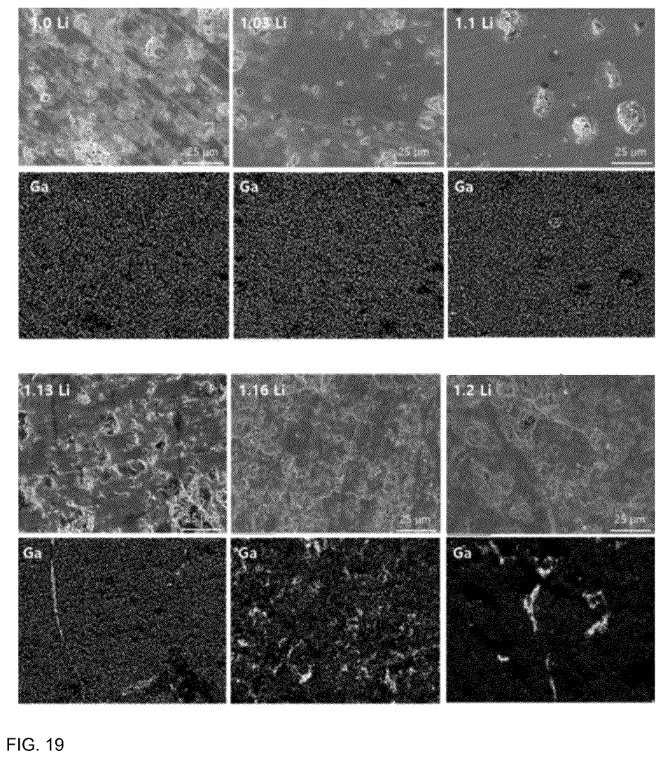

FIG. 15 shows the pelletized solid electrolytes of Examples 2 to 4 and Comparative Examples 7 to 9. FIG. 16 shows results of X-ray diffraction analysis of the solid electrolytes according to Examples 2 to 4 and Comparative Examples 7 to 9. FIG. 17 shows results of measurement of lithium ion conductivity of the solid electrolytes according to Examples 2 to 4 and Comparative Examples 7 to 9. FIG. 18 shows results of Raman analysis of the solid electrolyte according to Example 4. FIG. 19 shows results of analyzing the solid electrolytes according to Examples 2 to 4 and Comparative Examples 7 to 9 using a scanning electron microscope and energy dispersive spectrometer.

Referring to the diameters of FIG. 15, the samples all showed a shrinkage rate of about 85% or more.

Referring to FIG. 16, in Comparative Examples 7 and 8, a secondary phase, La₂Zr₂O₇, was formed due to the lack of lithium. In contrast, Examples 2 to 4 and Comparative Example 9 showed a tetragonal crystal structure due to the sufficient supply of lithium. Also, referring to FIG. 18, the solid electrolyte of Example 4 showed a tetragonal crystal structure in Raman analysis.

Referring to FIG. 19, in Examples 2 to 4 and Comparative Example 9, gallium was present at the grain boundary, and the area of the grain boundary where the gallium was present was enlarged with an increase in the amount of lithium.

Referring to FIG. 17, Examples 2 to 4, in which the amount of lithium was high, exhibited high lithium ion conductivity compared to Comparative Examples 7 and 8. Meanwhile, Comparative Example 9, in which the amount of lithium was the highest, showed low lithium ion conductivity of about 0.279 mS·cm⁻¹, which is deemed to be because the area of the grain boundary where gallium was present was enlarged and the movement path of lithium was hindered.

### Examples 5 to 8 and Comparative Example 10

Each solid electrolyte was manufactured in the same manner as Example 1, with the exception that the composition of lithium oxide was changed as shown in Table 3 below.

TABLE 3

| | Composition | |
|---|---|---|
| | (Chemical Formula 3: | m in Chemical |
| Classification | Li_{7.7-3m-0.534}Al_{0.172}GaₘLa₃Zr_{1.982}Ta_{0.018}O₁₂) | Formula 3 |
| Comparative | Li_{7.166}Al_{0.172}La₃Zr_{1.982}Ta_{0.018}O₁₂ | 0 |
| Example 10 | | |
| Example 5 | Li_{6.95}Al_{0.172}Ga_{0.07}La₃Zr_{1.982}Ta_{0.018}O₁₂ | 0.07 |
| Example 6 | Li_{6.842}Al_{0.172}Ga_{0.107}La₃Zr_{1.982}Ta_{0.018}O₁₂ | 0.107 |
| Example 7 | Li_{6.734}Al_{0.172}Ga_{0.142}La₃Zr_{1.982}Ta_{0.018}O₁₂ | 0.142 |
| Example 8 | Li_{6.626}Al_{0.172}Ga_{0.178}La₃Zr_{1.982}Ta_{0.018}O₁₂ | 0.178 |

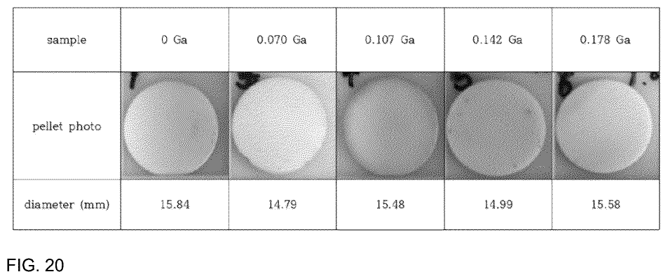

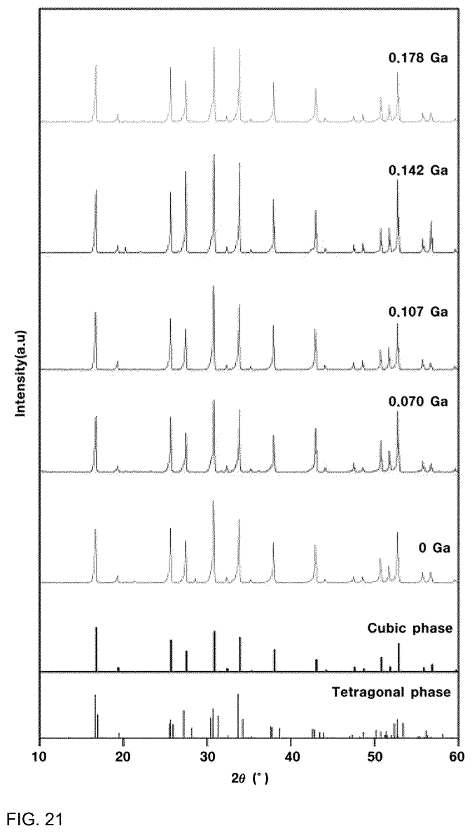

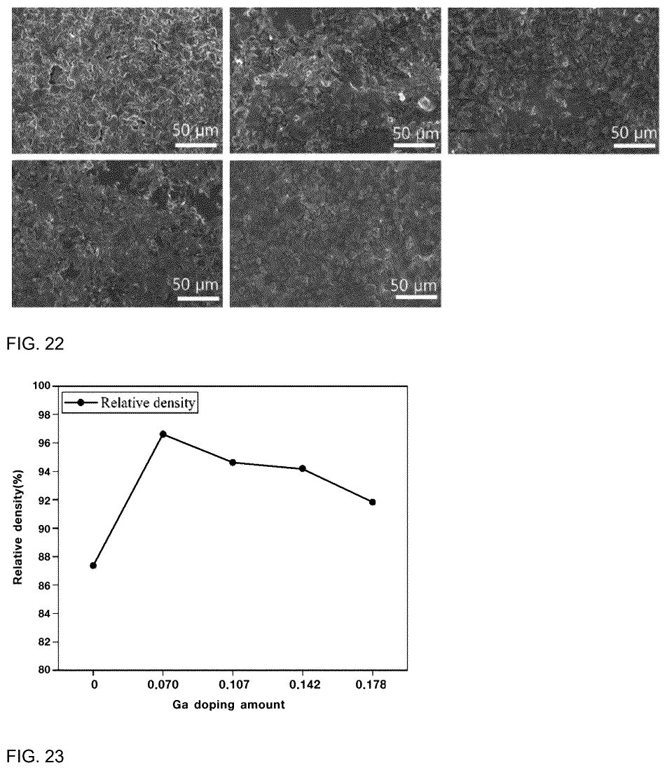

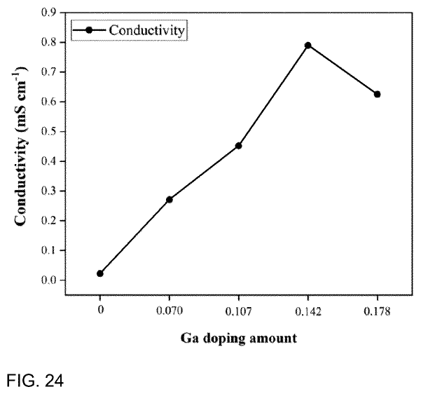

FIG. 20 shows the pelletized solid electrolytes of Examples 5 to 8 and Comparative Example 10. FIG. 21 shows results of X-ray diffraction analysis of the solid electrolytes according to Examples 5 to 8 and Comparative Example 10. FIG. 22 shows results of analyzing the solid electrolytes according to Examples 5 to 8 and Comparative Example 10 using a scanning electron microscope. FIG. 23 shows results of measurement of relative density of the solid electrolytes according to Examples 5 to 8 and Comparative Example 10. FIG. 24 shows results of measurement of lithium ion conductivity of the solid electrolytes according to Examples 5 to 8 and Comparative Example 10.

Referring to the diameters of FIG. 20, the samples all showed a shrinkage rate of about 85% or more.

Referring to FIG. 21, Examples 5 to 8 and Comparative Example 10 all showed a tetragonal crystal structure. Referring to FIG. 22, the grain boundary was filled with an increase in the amount of doped gallium from Comparative Example 10 to Example 8.

Referring to FIG. 23, Comparative Example 10 showed a low relative density of about 87.36% because gallium was not deposited at the grain boundary. In contrast, Example 5 showed a high relative density of about 96.61% due to the presence of gallium at the grain boundary.

Referring to FIG. 24, Examples 5 to 8 all showed higher lithium ion conductivity than Comparative Example 10.

A coating layer was formed by deposing gold (Au) on both surfaces of the solid electrolyte according to each of Example 7 and Comparative Example 10 using a sputter coater (SCD 005, Bal-Tec, Milton, NY, USA) under conditions of 20 mA and 20 seconds. The result was rested at about 15° C. to 25° C. for about 1 hour to form an intermediate layer.

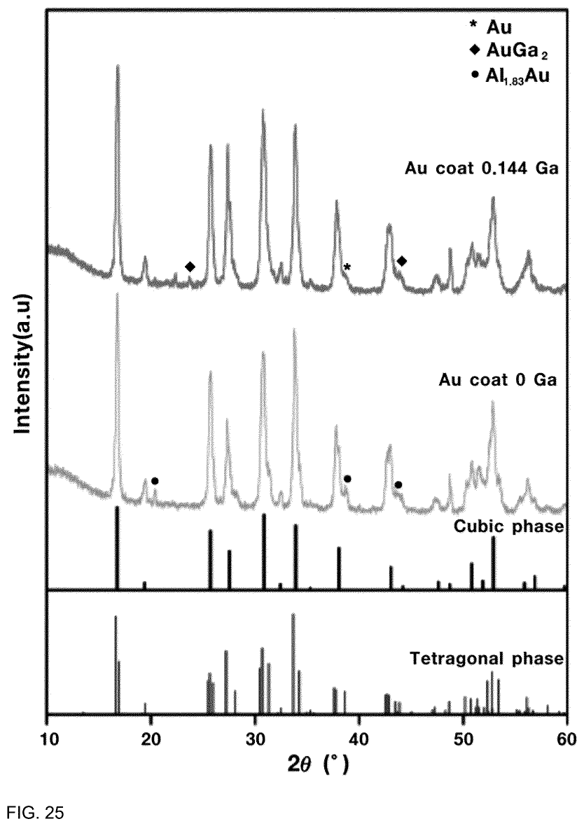

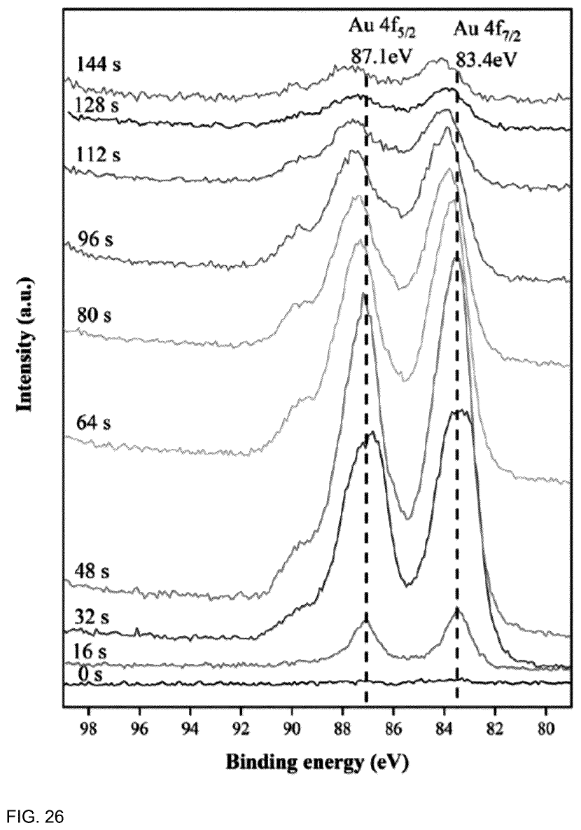

FIG. 25 shows results of X-ray diffraction analysis of the solid electrolytes according to Example 7 and Comparative Example 10. Referring thereto, in Example 7, cubic phase LLZO, Au, and AuGa₂ peaks were detected. FIG. 26 shows results of X-ray photoelectron spectroscopy of the solid electrolyte according to Example 7. Referring thereto, in Example 7, Au 4f^{5/2} and 4f^{7/2} peaks were separated and a Ga—Au alloy peak was observed.

In contrast, cubic phase LLZO and Au peaks were detected in the X-ray diffraction analysis results of Comparative Example 10, which means that only LLZO and Au deposited on the surface were present.

### Examples 9 to 11 and Comparative Example 11

A starting material was prepared by weighing and mixing Li₂CO₃, La₂O₃, ZrO₂, Ga₂O₃, Al₂O₃, and Ta₂O₅ according to the composition of Li_{6.734}Al_{0.172}Ga_{0.142}La₃Zr_{1.982}Ta_{0.018}O₁₂. The starting material was pulverized using a planetary ball mill. The result was dried and then heat-treated in a furnace at about 900° C. for about 6 hours, yielding lithium oxide.

The lithium oxide was sintered for about 100 minutes at the temperature shown in Table 4 below.

TABLE 4

| | Sintering |
|---|---|
| Classification | temperature [° C.] |
| Comparative | 900 |
| Example 11 | |
| Example 9 | 1,000 |
| Example 10 | 1,100 |
| Example 11 | 1,250 |

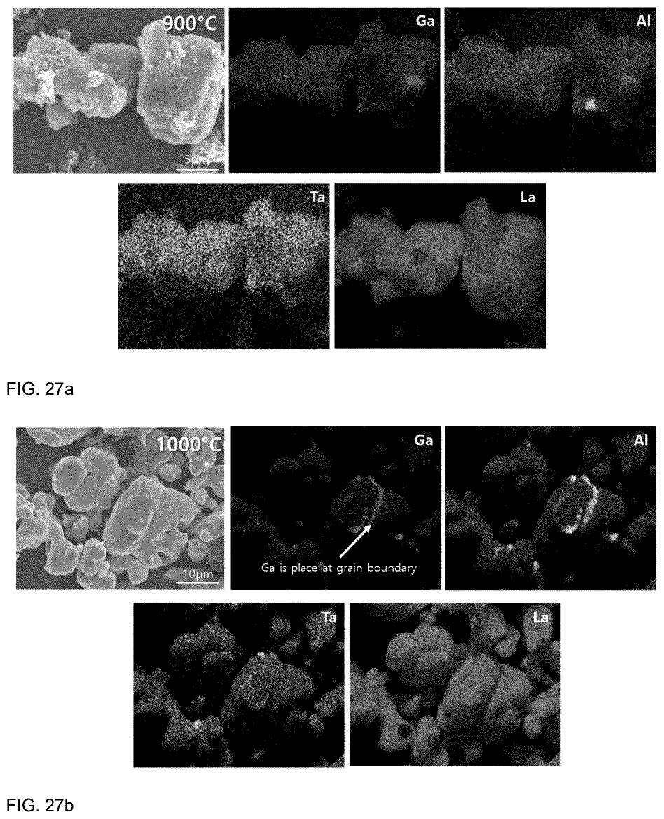

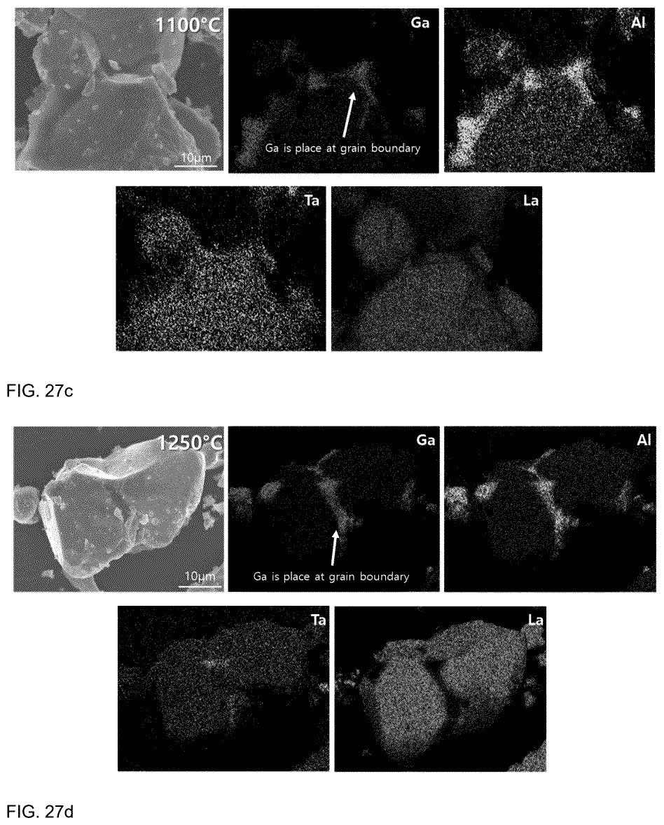

FIG. 27a to 27d shows results of analyzing the solid electrolytes according to Examples 9 to 11 and Comparative Example 11 using a scanning electron microscope and an energy dispersive spectrometer. Referring thereto, in Comparative Example 11, gallium precipitation was not observed between the grains. In Examples 9 to 11, gallium precipitation was observed between the grains. Therefore, in order to precipitate gallium, the sintering temperature has to be adjusted to 1,000° C. or higher.

### Example 12 and Comparative Example 12

A starting material was prepared by weighing and mixing Li₂CO₃, La₂O₃, ZrO₂, Ga₂O₃, Al₂O₃, and Ta₂O₅ according to the composition of Li_{6.95}Al_{0.172}Ga_{0.070}La₃Zr_{1.982}Ta_{0.018}O₁₂. The starting material was pulverized using a planetary ball mill. The result was dried and then heat-treated in a furnace at about 900° C. for about 6 hours, yielding lithium oxide.

The lithium oxide was pulverized using a planetary ball mill at about 200 rpm for the time shown in Table 5 below. The result was mixed with a polyvinyl alcohol solution as a binder, placed in a mold with a diameter of about 20 mm, and pressurized at about 72 MPa to obtain pellets. The pellets were sintered.

TABLE 5

| | Pulverization |
|---|---|
| Classification | time [hour] |
| Example 12 | 2 |
| Comparative | 12 |
| Example 12 | |

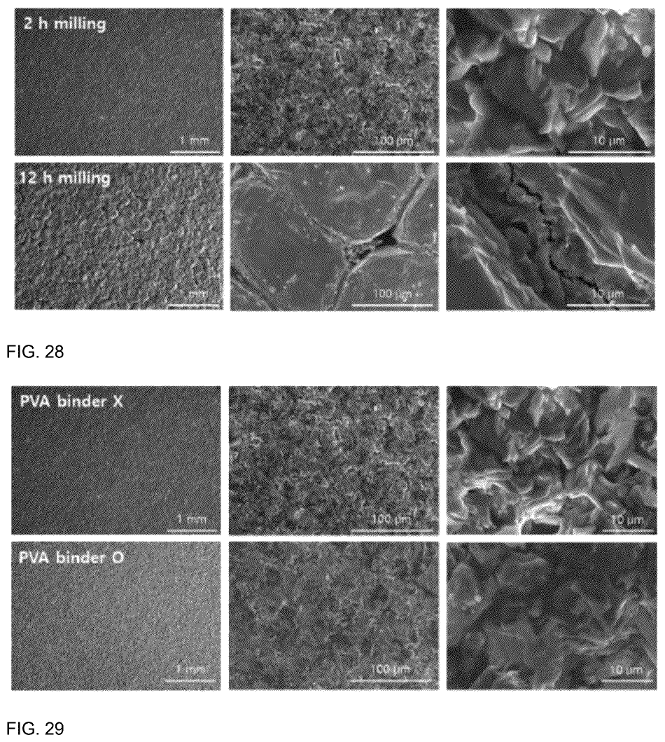

FIG. 28 shows scanning electron microscope images of the solid electrolytes according to Example 12 and Comparative Example 12. Referring thereto, in Example 12, densification and compactification of pellets through sintering were achieved in a balanced manner. In contrast, in Comparative Example 12, the size of the lithium oxide grains was smaller than that in Example 12 due to excessive pulverization, so the grain boundary was enlarged due to disproportionately high compactification during pellet sintering.

### Example 13

A starting material was prepared by weighing and mixing Li₂CO₃, La₂O₃, ZrO₂, Ga₂O₃, Al₂O₃, and Ta₂O₅ according to the composition of Li_{6.95}Al_{0.172}Ga_{0.070}La₃Zr_{1.982}Ta_{0.018}O₁₂. The starting material was pulverized using a planetary ball mill. The result was dried and then heat-treated in a furnace at about 900° C. for about 6 hours, yielding lithium oxide.

The lithium oxide was pulverized using a planetary ball mill. The result was mixed with a polyvinyl alcohol solution as a binder, placed in a mold with a diameter of about 20 mm, and pressurized at about 72 MPa to obtain pellets. The pellets were sintered at a furnace.

### Comparative Example 13

A solid electrolyte was manufactured in the same manner as Example 13, with the exception that the polyvinyl alcohol solution as a binder was not used.

FIG. 29 shows scanning electron microscope images of the solid electrolytes according to Example 13 and Comparative Example 13. Referring thereto, in Example 13, the sintering density was increased by the binder and thus the area of the grain boundary was small, whereas in Comparative Example 13, pores were observed at the grain boundary due to the absence of the binder.

### Example 14

A starting material was prepared by weighing and mixing Li₂CO₃, La₂O₃, ZrO₂, Ga₂O₃, Al₂O₃ and Ta₂O₅ according to the composition of Li_{6.734}Al_{0.172}Ga_{0.142}La₃Zr_{1.982}Ta_{0.018}O₁₂. The starting material was pulverized using a planetary ball mill. The result was dried and then heat-treated in a furnace at about 900° C. for about 6 hours, yielding lithium oxide.

The lithium oxide was pulverized using a planetary ball mill. The result was mixed with a polyvinyl alcohol solution as a binder, placed in a mold with a diameter of about 20 mm, and pressurized at about 72 MPa to obtain pellets. The pellets were sintered at a furnace.

Both surfaces of the sintered lithium oxide were polished with 5,000 grit sandpaper.

### Comparative Example 14

A solid electrolyte was manufactured in the same manner as in Example 14, with the exception that both surfaces of the sintered lithium oxide were not polished.

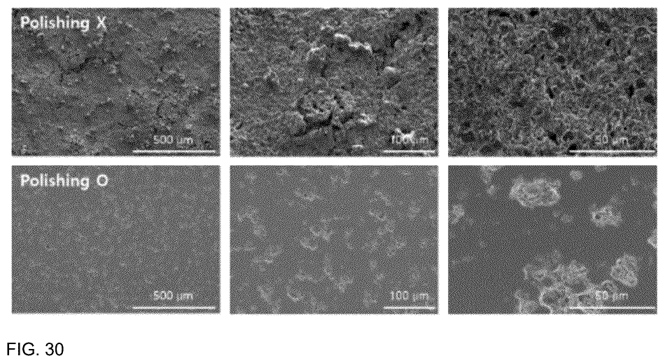

FIG. 30 shows scanning electron microscope images of the solid electrolytes according to Example 14 and Comparative Example 14. Referring thereto, the solid electrolyte according to Example 14 had a smooth surface. In contrast, the surface of the solid electrolyte of Comparative Example 14 was covered with the mother powder used during sintering.

As is apparent from the above description, according to the present disclosure, a solid electrolyte for a lithium secondary battery with high lithium ion conductivity and a method of manufacturing the same can be provided.

According to the present disclosure, a solid electrolyte for a lithium secondary battery with high relative density and a method of manufacturing the same can be provided.

According to the present disclosure, a solid electrolyte for a lithium secondary battery with excellent wettability to lithium and a method of manufacturing the same can be provided.

According to the present disclosure, a solid electrolyte for a lithium secondary battery with low interfacial resistance and a method of manufacturing the same can be provided.

According to the present disclosure, a solid electrolyte for a lithium secondary battery with excellent charge/discharge stability and a method of manufacturing the same can be provided.

The effects of the present disclosure are not limited to the foregoing. It should be understood that the effects of the present disclosure include all effects that can be inferred from the description of the present disclosure.

As described hereinbefore, although the embodiments have been described through limited examples and drawings, those skilled in the art will appreciate that various modifications and alterations are possible from the above description. For example, even when the described techniques are performed in an order different from the described method and/or even when the described components are linked or combined in a different form from the described method or are replaced or substituted by other components or equivalents, it is possible to achieve appropriate results. Therefore, other embodiments, other examples, and equivalents to the claims are also within the scope of the following claims.

1. A solid electrolyte for a lithium secondary battery, comprising:
lithium oxide comprising at least one substitution element selected from the group consisting of gallium (Ga), aluminum (Al), tantalum (Ta), and combinations thereof and having a predetermined shape;
a coating layer comprising a noble metal and located on a surface of the lithium oxide; and
an intermediate layer comprising an alloy of the substitution element and the noble metal and located between the lithium oxide and the coating layer.

2. The solid electrolyte of claim 1, wherein the lithium oxide comprises a plurality of grains and a grain boundary between the grains, and a metal derived from the substitution element is precipitated along the grain boundary.

3. The solid electrolyte of claim 1, wherein the lithium oxide is represented by Chemical Formula 1 below:
LiₐAl_{b}Ga_{c}La₃Zr_{d}TaₑO₁₂ [Chemical Formula 1]
in Chemical Formula 1, a, b, c, d, and e are 6≤a≤8, 0<b<1, 0<c<1, 1<d<2, and 0<e<1, with satisfying d+e=2.

4. The solid electrolyte of claim 1, wherein the lithium oxide is represented by Chemical Formula 2 below:
Li_{7n-0.966}Al_{0.172}Ga_{0.144}La₃Zr_{1.982}Ta_{0.018}O₁₂ [Chemical Formula 2]
in Chemical Formula 2, n is 1.03<n<1.2.

5. The solid electrolyte of claim 1, wherein the lithium oxide is represented by Chemical Formula 3 below:
Li_{7.7-3m-0.534}Al_{0.172}GaₘLa₃Zr_{1.982}Ta_{0.018}O₁₂ [Chemical Formula 3]
in Chemical Formula 3, m is 0<m≤0.178.

6. The solid electrolyte of claim 1, wherein the lithium oxide is a sintered body.

7. The solid electrolyte of claim 1, wherein the lithium oxide has a relative density of 90% or more.

8. The solid electrolyte of claim 1, wherein the lithium oxide has a surface roughness (Rₐ) of 1 μm or less.

9. The solid electrolyte of claim 1, wherein the lithium oxide has a surface roughness (Rₐ) of 100 nm or less.

10. The solid electrolyte of claim 1, wherein the noble metal comprises at least one selected from the group consisting of silver (Ag), gold (Au), platinum (Pt), and combinations thereof.

11. The solid electrolyte of claim 1, wherein the lithium oxide is blocked from outside by the intermediate layer.

12. The solid electrolyte of claim 1, wherein the intermediate layer comprises an alloy of gallium (Ga) and gold (Au).

13. The solid electrolyte of claim 1, wherein the intermediate layer has a thickness of 1 nm to 10 nm.

14. A method of manufacturing the solid electrolyte of claim 1, comprising:
preparing lithium oxide comprising at least one substitution element selected from the group consisting of gallium (Ga), aluminum (Al), tantalum (Ta), and combinations thereof and having a predetermined shape;
precipitating a metal derived from the substitution element along a grain boundary of the lithium oxide by sintering the lithium oxide;
polishing a surface of the sintered lithium oxide;
obtaining an intermediate by forming a coating layer comprising a noble metal on the polished surface of the lithium oxide; and
forming an intermediate layer located between the lithium oxide and the coating layer and comprising the substitution element and the noble metal by resting the intermediate.

15. The method of claim 14, further comprising pulverizing the lithium oxide by ball milling at a speed of 100 rpm to 300 rpm for 1 hour to less than 12 hours, before sintering the lithium oxide.

16. The method of claim 14, wherein precipitating the metal comprises sintering the lithium oxide at 1,000° C. to 2,000° C. for 10 minutes to 200 minutes.

17. The method of claim 14, wherein the coating layer is formed by depositing the noble metal on the polished surface of the lithium oxide.

18. The method of claim 14, wherein forming the intermediate layer comprises resting the intermediate at 15° C. to 25° C. for 10 minutes to 2 hours.
